(19) United States
(12) Patent Application Publication
(10) Pub. No.: US 2010/0072437 A1
(43) Pub. Date: Mar. 25, 2010

(54) COMPOSITION, COLOR FILTER AND PROCESS FOR PREPARING COLOR FILTER

(75) Inventor: Hiroshi Takeuchi, Ashigarakami-gun (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/563,604

(22) Filed: Sep. 21, 2009

(30) Foreign Application Priority Data
Sep. 22, 2008 (JP) 2008-242218

(51) Int. Cl. G02F 1/361; B05D 3/10

(52) U.S. Cl. 252/582; 427/385.5

(57) ABSTRACT

The invention relates to a composition comprising at least a polymer which comprises a repeating unit represented by formula (1), a discotic compound and a pigment. In the formula, each of L¹, L², L³ and L⁴ independently represents a divalent linking group; X represents an (n+2)-valent linking group; R¹ represents a substituted or non-substituted, alkyl group, alkenyl group, alkynyl group, aryl group, aralkyl group, or hetero ring residue; n represents an integer from 1 to 4, and n (L⁴)s and n (R¹)s may be same with or different from each other; and MG represents a mesogen group.

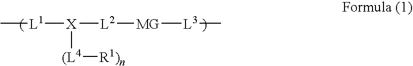

### CROSS-REFERENCE TO RELATED APPLICATIONS

This application claims benefit of priority under 35 U.S.C. 119 to Japanese Patent Application No. 2008-242218, filed on Sep. 22, 2008, which is expressly incorporated herein by reference in its entirety.

### BACKGROUND OF THE INVENTION

1. Technical Field

The present invention relates to a composition useful for preparing an optical component which contains colored layer(s), such as color filter and so forth, a color filter which contains colored layer(s) showing retardation, and a process for preparing the color filter.

2. Background Art

Color liquid crystal display device (abbreviated as LCD, hereinafter) enables color display, generally by adopting a color filter. The color filter generally has a light-shielding black matrix (BM), and color layers of red (R), green (G) and blue (B) as three primary colors of light. The color LCD gives color display by controlling amount of light transmissible through the individual colored layers of R, G and B, with the aid of a liquid crystal layer and polarizing plates. Known methods of preparing the color filter include dying process, pigment dispersion process (resist process), printing process, electro-deposition process and so forth. Among these, the pigment dispersion process (resist process) has been establishing the mainstream.

The LCD generally adopts also a retardation film. The retardation film is used for improving viewing angle characteristics of LCD. With the retardation film, the LCD may be observable not only from the axial direction (the direction of normal line on the screen), but also from oblique directions. More specifically, the retardation film functions to resolve leakage of light anticipated in oblique views, and to suppress degradation or inversion of contrast from occurring in oblique views. In particular, the LCD aimed for television set may be watched often by a plurality of observers, where the functions of the retardation film add importance.

For example, for vertical alignment mode (generally referred to as VA mode) LCD, there has been proposed a system based on a combination of a retardation layer which has an optical axis normal to a substrate and has negative birefringence (negative C-plate), and a retardation layer which has an optical axis in parallel with the substrate and has a positive birefringence (positive A-plate). These retardation layers have been made using stretched transparent polymer films or films on which alignment of a liquid crystalline compound, having a polymerizable group, is fixed. However, with increase in the screen size of LCD used for television set, requirements for the display characteristics have been becoming more severe, in pursuit of a higher quality of display. In particular, there has been a strong demand for reducing color shift possibly observed in oblique views. For the purpose of achieving ideal optical compensation of the LCD over the entire range of visible light region at a certain angle of observation, the LCD is necessarily adjusted to have a necessary amount of retardation for optical compensation depending on wavelength. On the other hand, wavelength dependence of retardation of the retardation film used for optical compensation is determined by characteristics of a material composing the film, where the wavelength dependence of the amount of retardation required for ideal optical compensation of the LCD does not always agree with the wavelength dependence of retardation of the retardation film, but often results in disagreement. In most of such cases, the optical design is optimized generally at the wavelength of green (G) where the visual sensitivity becomes maximum, in other words, the optical design is aimed at achieving ideal optical compensation at the wavelength of G. However, this case may fail in achieving correct optical compensation at the wavelengths of red (R) and blue (B), and thereby the display screen in the black state may appear as a reddish purple screen, with larger amounts of leakage of R and B lights when viewed at larger angles.

For example, Japanese Laid-Open Patent Publication (JP-A) No. 2006-64858 discloses a color filter having a retardation control layer stacked on the individual colored layers of a color filter. The optical compensation herein for the individual colors may be approximated to the ideal, by varying the thickness of the retardation control layer for every colored layer. On the other hand, it may be difficult to form such double-layered structure of the colored layer and the retardation control layer in a fine region, making the process of manufacturing labor-consuming.

The manufacturing is supposed to be simplified if a single layer which functions both as the colored layer and as the retardation layer is obtained. However, addition of any compound which induces retardation into a composition having pigments dispersed therein may impair dispersion stability of the pigments, and/or may impair ability of expressing retardation of the additive.

Japanese Laid-Open Patent Publication No. 2002-292264 discloses a dispersion aid containing a liquid crystalline mesogen group, used as a dispersion aid for image-forming material. The publication, however, does not describe combined use of the compound having an ability of expressing retardation with the dispersion aid.

### SUMMARY OF THE INVENTION

An object of the present invention is to provide a novel composition useful for preparing an optical component having colored layers, such as a color filter and so forth.

It is another object of the present invention to provide a novel composition useful for forming a colored retardation layer.

It is still another object of the present invention to provide a color filter having colored layers showing retardation.

The means for achieving the objects are as follows:

[1] A composition comprising at least a polymer which comprises a repeating unit represented by formula (1), a discotic compound and a pigment:

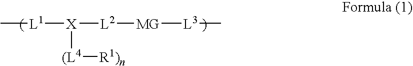

where, each of L¹, L², L³ and L⁴ independently represents a divalent linking group; X represents an (n+2)-valent linking group; R¹ represents a substituted or non-substituted, alkyl group, alkenyl group, alkynyl group, aryl group, aralkyl group, or hetero ring residue; n represents an integer from 1 to 4, and n (L⁴)s and n (R¹)s may be same with or different from each other; and MG represents a mesogen group.

[2] The composition of [1], wherein in formula (1), R¹ comprises an alkyl chain, alkenyl chain or alkynyl chain, having 3 or more and less than 20 carbon atoms.
[3]. The composition of [1] or [2], wherein in formula (1), X represents a trivalent group represented by the formula below:

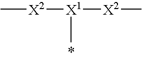

wherein, X¹ represents an alkylene group having 3 or more and less than 20 carbon atoms, X² represents an oxygen atom or sulfur atom, and * represents a binding site with L⁴.

[4] The composition of any one of [1]-[3], wherein in formula (1), each of L¹, L², L³ and L⁴ independently represents any one divalent linking group selected from a group consisting of a substituted or non-substituted alkylene group, a substituted or non-substituted arylene group, a substituted or non-substituted divalent hetero ring residue, —CO—, —NH—, oxygen atom, sulfur atom, and any combinations thereof.
[5] The composition of any one of [1]-[4], wherein in formula (1), L¹ represents —CO-L¹¹- or NH-L¹¹-; L³ represents -L³¹-NH— or L³¹-CO—; L² represents -L²¹-CONH-L²²- or L²¹-NHCO-L²²-; each of L¹¹, L³¹, L²¹ and L²² independently represents a single bond, substituted or non-substituted alkylene group, substituted or non-substituted arylene group, or substituted or non-substituted divalent hetero ring residue.
[6] The composition of any one of [1]-[5], wherein in formula (1), MG represents a mesogen group represented by any one of formulae below:

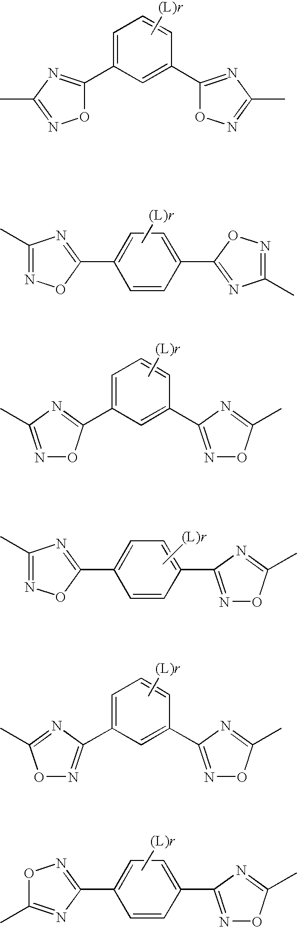

where, L represents a substituent; r represents an integer form 0 to 4; and if r=2, two (L)s may be same with or different from each.

[7] The composition of any one of [1]-[6], wherein the discotic compound and MG in formula (1) in the above have a same partial structure.
[8] The composition of any one of [1]-[7], wherein the discotic compound is a compound represented by formula (10) below, and MG in formula (1) in the above represents a group represented by formula (1a) below, or a group containing a group represented by formula (1a) below as a partial structure:

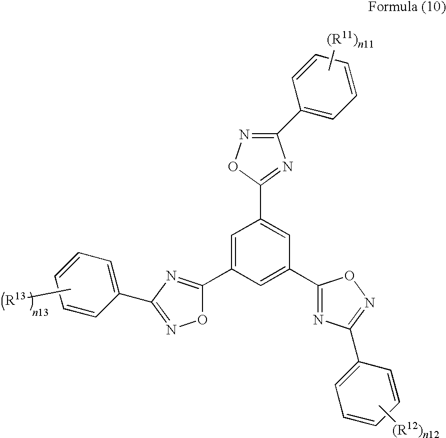

where, each of R¹¹, R¹² and R¹³ independently represents a substituent, each of n11, n12 and n13 represents an integer from 1 to 4, n11 (R₁₂)s, n12 (R¹²)s and n13 (R¹³)s may be same with or different from each other;

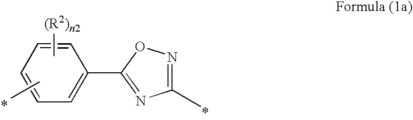

where, R² represents a substituent, n2 represents an integer from 0 to 4, and if n2≧2, (R²)s may be same with or different from each other; and * represents a binding site to L² or L³, or a binding site to other partial structure in MG.

[9] The composition of any one of [1]-[8], wherein said pigment is an organic pigment for color filters.
[10] A color filter comprising at least one color of colored layer composed of said composition of any one of [1]-[9].
[11] The color filter of [10], wherein said colored layer shows retardation.
[12] A method for preparing a color filter comprising:

applying the composition of any one of [1]-[9] to a surface to thereby form a coated layer;

drying said coated layer to thereby align molecules of the discotic compound; and

allowing a polymerization reaction to proceed to thereby fix the state of alignment.

### DETAILED DESCRIPTION OF THE INVENTION

The invention is described in detail hereinunder. Note that, in this patent specification, any numerical expressions in a style of “numerical value 1 to numerical value 2” will be used to indicate a range including the lower and upper limits.

### 1. Composition

The present invention relates to a composition which contains at least a polymer which contains a repeating unit represented by formula (1) below, a discotic compound, and a pigment. By adding the polymer which contains the repeating unit represented by formula (1) below to the composition, the discotic compound and the pigment may coexist in the composition without impairing alignment property of the discotic compound molecules, while keeping desirable dispersibility of the pigment. The composition of the present invention is useful for preparing an optical component having colored layers, such as a color filter and so forth. By further selecting the discotic compound from those having desired wavelength dispersion characteristics of intrinsic birefringence, and/or by adjusting the thickness of the colored layers, a color filter capable of achieving ideal optical compensation with respect to each of three primary colors R, G and B of light may be provided.

The individual ingredients used for the composition of the present invention will be explained below.

### 1.-1 Polymer

The composition of the present invention contains a polymer which contains a repeating unit represented by formula (1) below. The polymer functions as a dispersion aid for the pigment, and also as an alignment enhancing agent for the discotic compound molecules.

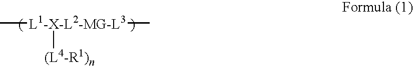

In formula (1), each of L¹, L², L³ and L⁴ independently represents a divalent linking group; X represents an (n+2)-valent linking group; R¹ represents a substituted or non-substituted, alkyl group, alkenyl group, alkynyl group, aryl group, alalkyl group, or heterocyclic residue, n represents an integer from 1 to 4, n (L⁴)s and n (R¹)s may be same with or different from each other; and MG represents a mesogen group.

Examples of each of L¹, L², and L³ in formula (1) include substituted or non-substituted alkylene group, substituted or non-substituted arylene group, substituted or non-substituted divalent heterocyclic residue, —CO—, —NH—, oxygen atom, sulfur atom, and any combinations thereof.

Preferable examples of L¹ include —CO-L¹¹- and —NH-L¹¹-.

Preferable examples of L³ include -L³¹-NH— and -L³¹-CO—.

Preferable examples of L² include -L²¹-CONH-L²²- and -L²¹-NHCO-L²²-.

Preferable examples of the combination of L¹, L² and L³ are that L¹ is —CO-L¹¹-, L³ is -L³¹-NH— and L² is -L²¹-CONH-L²²-; and that L¹ is —NH-L¹¹-, L³ is -L³¹-CO—, and L² is -L²¹-NHCO-L²²-.

L¹¹_{, L}³¹, L²¹ and L²² each represent a single bond, substituted or non-substituted alkylene group, substituted or non-substituted arylene group, or substituted or non-substituted bivalent hetero ring residue. Examples of the substituted thereof include halogen atoms such as fluorine atom, chlorine atom, bromine atom and iodine atom; linear or branched and substituted or non-substituted alkyls (preferably C₁₋₃₀ alkyls) such as methyl, ethyl, n-propyl, isopropyl, tert-butyl, n-octyl and 2-ethyl hexyl; substituted or non-substituted cycloalkyls (preferably C₃₋₃₀ cycloalkyls) such as cyclohexyl, cyclopentyl and 4-n-dodecyl cyclohexyl; substituted or non-substituted bicycloalkyls (preferably C₅₋₃₀ bicycloalkyls which are residues of C₅₋₃₀ bicycloalkanes without a hydrogen atom) such as bicyclo [1,2,2] heptane-2-yl and bicyclo [2,2,2] octane-3-yl; substituted or non-substituted alkenyls (preferably C₂₋₃₀ alkenyl) such as vinyl and allyl; substituted or non-substituted cycloalkenyls (preferably C₃₋₃₀ cycloalkenyl which are residues C₃₋₃₀ cycloalkens without a hydrogen atom) such as 2-cyclopentene-1-yl and 2-cyclohexene-1-yl; substituted or non-substituted bicycloalkenyls (preferably C₅₋₃₀ bicycloalkenyls which are residues of C₅₋₃₀ bicycloalkenes without a hydrogen atom) such as bicyclo[2,2,1]hepto-2-en-1-yl and bicycl [2,2,2]octo-2-en-4-yl; substituted or non-substituted alkynyls (preferably C₂₋₃₀ alkynyl) such as ethynyl and propargyl; substituted or non-substituted aryls (preferably C₆₋₃₀ aryls) such as phenyl, p-tolyl and naphthyl; substituted or non-substituted heterocyclic group (preferably residues of aromatic or non aromatic 5- or 6-membered hetero-ring compounds without a hydrogen atom; and more preferably residues of aromatic 5- or 6-membered C₃₋₃₀ hetero-ring compounds without a hydrogen atom) such as 2-furyl, 2-thyenyl, 2-pyrimidyl, and 2-benzothiazolyl; cyano, hydroxyl, nitro, carboxyl, substituted or non-substituted alkoxys (preferably C₁₋₃₀ alkoxyl) such as methoxy, ethoxy, isopropoxy, tert-butoxy, n-octyloxy and 2-methoxyethoxy; substituted or non-substituted aryloxys (preferably C₆₋₃₀ aryloxys) such as phenoxy, 2-methylphenoxy, 4-tert-butyl phenoxy, 3-nitro phenoxy, and 2-tetradecanoyl aminophenoxy; silyloxys (preferably C₃₋₂₀ silyloxys) such as trimethyl silyloxy and tert-butyl dimethylsilyloxy; substituted or non-substituted heterocyclic oxy group (preferably C₂₋₃₀ heterocyclic oxy group) such as 1-phenyltetrazole-5-oxy and 2-tetrahydro pyranyloxy; substituted or non-substituted acyloxys (preferably formyloxy, C₂₋₃₀ alkylcarbonyloxys and C₆₋₃₀ arylcarbonyloxys) such as formyloxy, acetyloxy, pivaloyloxy, stearoyloxy, beozoyloxy and p-methoxyphenyl carbonyloxy; substituted or non-substituted carbamoyloxys (preferably non-substituted and substituted C₁₋₃₀ alkyl carbamoyloxys) such as N,N-dimethyl carbamoyloxy, N,N-diethyl carbamoyloxy, morpholino carbonyloxy, N,N-di-n-octylamino carbonyloxy and N-n-octyl carbamoyloxy; substituted or non-substituted alkoxycarbonyloxys (preferably C₂₋₃₀ alkoxycarbonyloxys) such as methoxycarbonyloxy, ethoxycarbonyloxy, tert-butoxycarbonyloxy and n-octylcarbonyloxy; substituted or non-substituted aryloxycarbonyloxys (preferably C₇₋₃₀ aryloxycarbonyloxys) such as phenoxycarbonyloxy, p-methoxyphenoxy carbonyloxy and p-n-hexadecyloxy phenoxy carbonyloxy; substituted or non-substituted aminos (preferably amino, C₁₋₃₀ alkylaminos and C₆₋₃₀ anilinos) such as amino, methylamino, dimethylamino, anilino, N-methyl-anilino and diphenyl amino; substituted or non-substituted acylaminos (preferably formylamino, C₁₋₃₀ alkylcarbonylaminos and C₆₋₃₀ arylcarbonylaminos) such as formylamino, acetylamino, pivaloylamino, lauroylamino and benzoylamino; substituted or non-substituted aminocarbonylaminos (preferably C₁₋₃₀ aminocarbonylaminos) such as carbamoylamino, N,N-dimethylaminocarbonylamino, N,N-diethylaminocarbonylamino and morpholino carbonylamino; substituted or non-substituted alkoxycarbonylaminos (preferably C₂₋₃₀ alkoxycarbonylaminos) such as methoxy carbonylamino, ethoxycarbonyl amino, tert-butoxycarbonyl amino, n-octadecyloxy carbonylamino and N-methyl-methoxy carbonylamino; substituted or non-substituted aryloxy carbonylaminos (preferably C₇₋₃₀ aryloxy carbonylaminos) such as phenoxy carbonylamino, p-chlorophenoxy carbonylamino and m-n-octyloxyphenoxy carbonylamino; substituted or non-substituted sulfamoylaminos (preferably C₀₋₃₀ sulfamoylaminos) such as sulfamoylamino, N,N-dimethylamino sulfonylamino and N-n-octylamino sulfamoylamino; substituted or non-substitute alkyl- or aryl-sulfonylaminos (preferably C₁₋₃₀ alkyl sulfonylaminos and C₆₋₃₀ aryl sulfonylaminos) such as methyl sulfonylamino, butyl sulfonylamino, phenyl sulfonylamino, 2,3,5-trichlorophenyl sulfonylamino and p-methylphenyl sulfonylamino; mercapto, substituted or non-substituted alkylthios (preferably C₁₋₃₀ alkylthios such as methylthio, ethylthio and n-hexadecylthio; substituted or non-substituted arylthios (preferably C₆₋₃₀ arylthios) such as phenylthio, p-chlorophenylthio and m-methoxy phenylthio; substituted or non-substituted heterocyclic thio group (preferably C₂₋₃₀ heterocyclic thio group) such as 2-benzothiazolylthio and 1-phenyl tetrazole-5-ylthio; substituted or non-substituted sulfamoyls (preferably C₀₋₃₀ sulfamoyls) such as N-ethyl sulfamoyl, N-(3-dodecyloxy propyl)sulfamoyl, N,N-dimethyl sulfamoyl, N-acetyl sulfamoyl, N-benzoyl sulfamoyl and N-(N′-phenyl carbamoyl)sulfamoyl; sulfo, substituted or non-substituted alkyl- or aryl-sulfinyls (preferably C₁₋₃₀ alkyl sulfinyls and C₆₋₃₀ aryl sulfinyls) such as methyl sulfinyl, ethyl sulfinyl, phenyl sulfinyl and p-methylphenyl sulfinyl; substituted or non-substituted alkyl- or aryl-sulfonyls (preferably C₁₋₃₀ alkyl sulfonyls and C₆₋₃₀ aryl sulfonyls) such as methyl sulfonyl, ethyl sulfonyl, phenyl sulfonyl and p-methylphenyl sulfonyl; substituted or non-substituted acyls (preferably formyl, C₂₋₃₀ alkylcarbonyls and C₇₋₃₀ arylcarbonyls) such as formyl, acetyl and pivaloyl benzoyl; substituted or non-substituted aryloxy carbonyls (preferably C₇₋₃₀ aryloxy carbonyls) such as phenoxy carbonyl, o-chlorophenoxy carbonyl, m-nitrophenoxy carbonyl and p-tert-butylphenoxy carbonyl; substituted or non-substituted alkoxycarbonyls (preferably C₂₋₃₀ alkoxycarbonyls) such as methoxy carbonyl, ethoxy carbonyl, tert-butoxy carbonyl and n-octadecyloxy carbonyl; substituted or non-substituted carbamoyls (preferably C₁₋₃₀ carbamoyls) such as carbamoyl, N-methyl carbamoyl, N,N-dimethyl carbamoyl, N,N-di-n-octyl carbamoyl and N-(methylsulfonyl)carbamoyl; substituted or non-substituted aryl- or heterocyclic azo group (preferably C₆₋₃₀ aryl azo group and C₃₋₃₀ heterocyclic azo group) such as phenyl azo, p-chlorophenyl azo and 5-ethylthio-1,3,4-thiaziazole-2-yl azo; imido group such as N-succinimido and N-phthalimido; substituted or non-substituted phosphinos (preferably C₂₋₃₀ phosphinos) such as dimethyl phosphino, diphenyl phosphino and methylphenoxy phosphino; substituted or non-substituted phosphinyls (preferably C₂₋₃₀ phosphinyls) such as phosphinyl, dioctyloxy phosphinyl and diethoxy phosphinyl; substituted or non-substituted phosphinyloxys (preferably C₂₋₃₀ phosphinyloxys) such as diphenoxy phosphinyloxy and dioctyloxy phosphinyloxy; substituted or non-substituted phosphinylaminos (preferably C₂₋₃₀ phosphinylaminos) such as dimethoxyphosphinyl amino and dimethylamino phosphinyl amino; and substituted or non-substituted silyls (preferably C₃₋₃₀ silyls) such as trimethyl silyl, tert-butyldimethyl silyl and phenyldimethyl silyl.

The substituents, which have at least one hydrogen atom, may be substituted by at least one substituent selected from these. Examples such substituent include alkylcarbonylaminosulfo, arylcarbonylaminosulfo, alkylsulfonylaminocarbonyl and arylsulfonylaminocarbonyl. More specifically, methylsulfonylaminocarbonyl, p-methylphenylsulfonylaminocarbonyl, acetylaminosulfonyl and benzoylaminosulfonyl are exemplified.

When each of L¹¹, L³¹, L²¹ and L²² independently represents a substituted alkylene group, preferable examples of the substituent include carboxyl group, halogen atom, cyano, acyl group, alkoxy group and acyloxy group. When each of L¹¹, L³¹, L²¹ and L²² independently represent a substituted arylene group, examples of the substituent include carboxyl group, halogen atom, cyano, acyl group, alkyl group, alkoxy group, and acyloxy group.

When each of L¹¹, L³¹, L²¹ and L²² independently represents a substituted heterocyclic residue, preferable examples of the substituent include carboxyl group, halogen atom, cyano group, acyl group, alkyl group, alkoxy group, and acyloxy group.

In formula (1), L⁴ represents a divalent linking group, and preferably represents an alkylene group, arylene group, divalent heterocyclic residue, —CO—, —NH—, oxygen atom, sulfur atom, and groups configured by combining these species. These groups may have substituents which are same as those represented by L¹¹ and so forth. Preferable examples of L⁴ include —O—C(═O)— and C(═O)O—.

In formula (1), X represents a (n+2)-valent linking group, preferably represents a trivalent or tetravalent linking group, and more preferably represents a trivalent linking group. Examples of the trivalent linking group include those represented by the formula below.

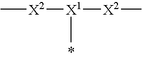

In the formula, X¹ represents an alkylene group having 3 or more and less than 20 carbon atoms, X² represents an oxygen atom or sulfur atom, and the symbol “*” represents a binding site with L⁴. X¹ preferably represents an alkylene group having 4 or more and less than 10 carbon atoms.

In formula (1), R¹ represents a substituted or non-substituted, alkyl, alkenyl, alkynyl, aryl, aralkyl or hetero ring residue, and preferably represents a substituted or non-substituted alkyl, alkenyl, alkynyl or aryl. These substituent may have one or plural substituents. Examples of the substituent include the above-exemplified examples of L¹¹. Preferably, R¹ represents a group containing an alkyl, alkenyl or alkynyl chain which may have 3 or more and less than 20 carbon atoms. For example, preferably, R¹ represents an alkyl, alkenyl or alkynyl having 4 or more and less than 16 carbon atoms; or an aryl or hetero ring residue having an alkoxy, alkenyloxy or alkynyloxy having 4 or more and less than 16 carbon atoms, an alkoxycarbonyl, alkenyloxycarbonyl or alkynyloxycarbonyl having 4 or more and less than 16 carbon atoms, or an alkycarbonyl, alkenylcarbonyl or alkynylcarbonyl having 4 or more and less than 16 carbon atoms.

In formula (1), MG represents a mesogen group. “Mesogen” means a basic skeleton of liquid crystal. Liquid crystal molecule is generally composed of a rigid partial structure and one or more flexible partial structures. The rigid partial structure is contributive to align the molecule, whereas the flexible partial structure is contributive to fluidity of liquid crystal. The rigid partial structure indispensable for liquid crystal is called “mesogen”. Various structures may be adoptable to the mesogen group in formula (I), without special limitations. The mesogen group may be selectable from a large variety of structures, depending on the structure of the discotic compound used in combination.

Examples of the mesogen group typically include mesogen group represented by MG-I below.

MG-I: -(A¹-Z¹)ₘ-A²-(Z³-A³)ₗ-

In the formula, each of A¹ and A³ independently represents a 1,4-phenylene group, heterocyclic group obtained by substituting one or two or more CH groups of 1,4-phenylene group with N, 1,4-cyclohexylene group, heterocyclic group obtained by possibly substituting one CH₂ group or two non-adjacent CH₂ groups of 1,4-cyclohexylene group with O and/or S, 1,4-cyclohexenylene group, or naphthalene-2,6-diyl group.

In the formula, A² represents a phenylene group, heterocyclic group obtained by substituting one or two or more CH groups of a phenylene group with N, cyclohexylene group, heterocyclic group obtained by possibly substituting one CH₂ group or two non-adjacent CH₂ groups of a cyclohexylene group with O and/or S, five-membered heterocyclic group containing N atom(s), cyclohexenylene group, or naphthalene diyl group. These groups may have a substituent. Examples of the substituent may be same as those represented by L¹¹ and so forth.

Each of Z¹ and Z³ independently represents —COO—, —OCO—, —CH₂CH₂—, —OCH₂—, —CH₂O—, —CH═CH—, —C≡C—, —CH═CH—COO—, —OCO—CH═CH—, divalent five-membered heterocyclic residue, or single bond, each of m and l independently represents 0, 1 or 2, preferably 1 or 2, and more preferably 1.

In the formula, Z¹ and Z² each preferably represent —COO—, —OCO—, —CH₂—CH₂—, —CH═CH—COO—, —OCO—CH═CH—, a divalent 5-membered hetero ring residue or a single bond.

Examples of the mesogen group represented by MG-I include, but are not limited to, those shown below.

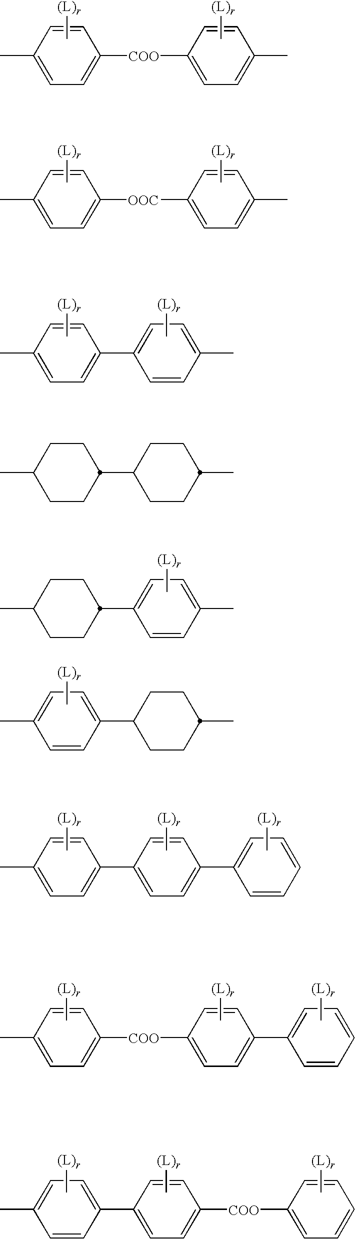

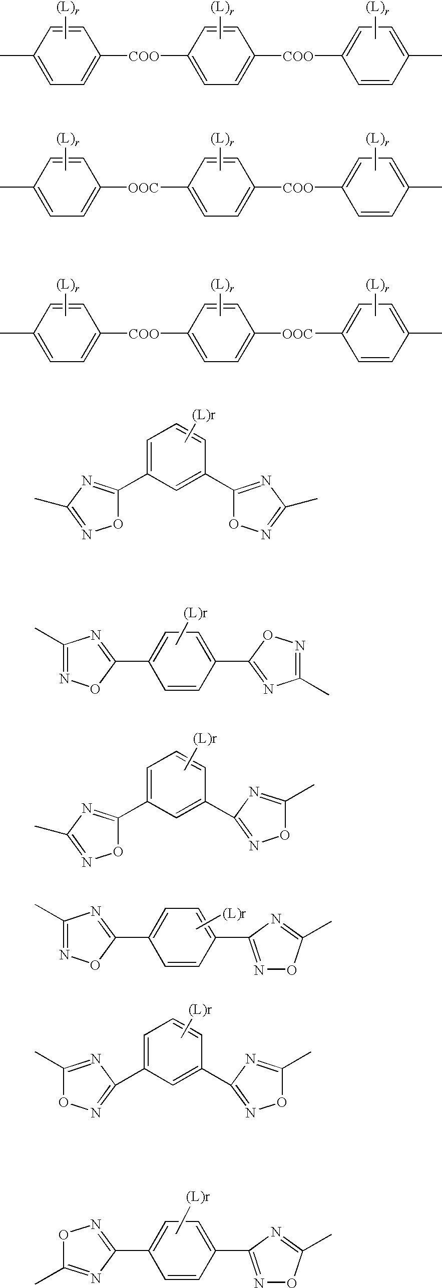

In the formula, r is an integer of from 0 to 4, and preferably 0, 1 or 2. When r is equal to or more than 2, plural L may be same or different from each other.

In the formula, L represents a substituent. Examples of the substituent include halogen atoms, cyano, nitro, C₁₋₅ alkyls, C₁₋₅ halogenated alkyls, C₁₋₅ alkoxys, C₁₋₅ alkylthios, C₁₋₅ acyls, C₂₋₆ acyloxys, C₂₋₅ alkoxycarbonyls, carbamoyl, C₂₋₆ alky-substituted carbamoyls, and C₂₋₆ amidos; and preferable examples of the substituent include halogen atoms, cyano, C₁₋₃ alkyls, C₁₋₃ halogenated alkyls, C₁₋₃ alkoxys and C₂₋₄ acyloxys.

More specifically, preferable examples of L include F, Cl, Br, CN, NO₂, CH₃, C₂H₅, OCH₃, OC₂H₅, COCH₃, COC₂H₅, CF₃, OCF₃, OCHF₂ and OC₂F₅; more preferable examples of L include F, Br, Cl, CN, CH₃, C₂H₅, OCH₃, COCH₃ and OCF₃; much more preferable examples of L include F, Br, CH₃, OCH₃ and COCH₃.

In the formula, r is an integer of from 0 to 4, and preferably 0, 1 or 2. When r is equal to or more than 2, plural L may be same or different from each other.

Examples of the mesogen group include mesogen groups which contain a partial structure represented by formula (1a) below. The polymer containing the mesogen group which has a partial structure represented by formula (1a) is preferably used in combination with a discotic compound represented by formula (10) described later.

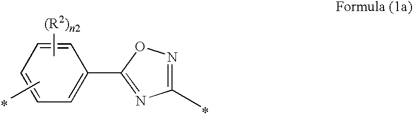

In formula (1a), R² represents a substituent, n2 represents an integer from 0 to 4, and if n2≧2, (R²)s may be same with or different from each other; and * represents a binding site to L² or L³, or a binding site to other partial structure in MG.

Examples of the substituent represented by R² may be similar to those represented by L¹¹ described in the above. Among others, the partial structure is preferably not substituted, that is n2=0; or preferably substituted, if n2=1 or 2, by substituent(s) selected from a halogen atom, cyano, alkyl group having 1 to 3 carbon atoms, halogen-substituted alkyl group having 1 to 3 carbon atoms, alkoxy group having 1 to 3 carbon atoms, and acyloxy group having 2 to 4 carbon atoms.

Specific examples of the mesogen group having the partial structure represented by formula (1a) in the above are shown below, without limiting the mesogen group. Symbols in the formula are used for the same meaning with those in formula (1a).

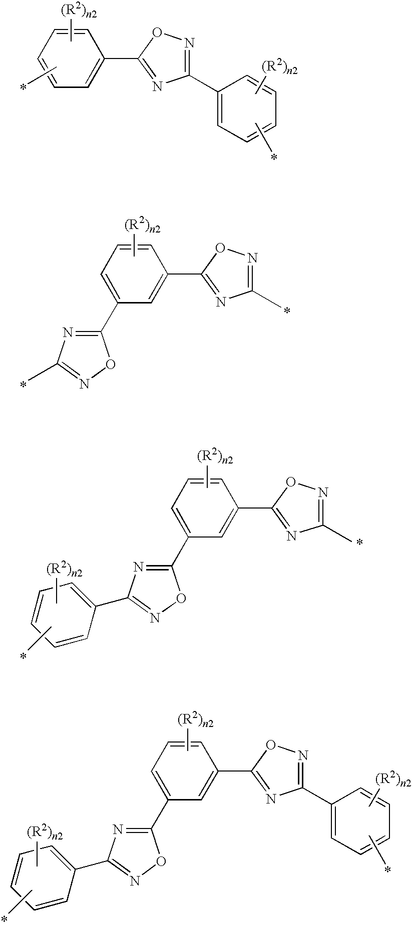

The polymer may be a homopolymer of the repeating unit represented by formula (1), or may be a copolymer containing a repeating unit other than that represented by formula (1). The degree of polymerization is not specifically limited, but the polymer is preferably any of those having an average molecular weight of 5000 or larger and 100000 or lower, in view of allowing the polymer to function as a dispersion aid for the pigment, and promoting alignment of the discotic compound. The degree of polymerization may be calculated as a polystyrene-equivalent value, by measuring the retention time by GPC using a polystyrene standard.

The polymer having the repeating unit represented by formula (1) may be prepared by any known methods.

### 1.-2 Discotic Compound

The composition of the present invention contains at least one species of discotic compound. The discotic compound is preferably a liquid crystalline compound. The liquid crystal compound is not specifically limited, and may be selected from various discotic compounds, preferably from discotic liquid crystal compounds. Examples of the discotic liquid crystal compounds include those having a core at the center of the molecule, radially substituted with straight-chain alkyl groups, alkoxy groups, or substituted benzoyloxy groups as side chains, and thereby showing liquid crystallinity. Examples of the discotic liquid crystal compound include triphenylene compound having the above-described substituents, trisubstituted benzene compound, hexasubstituted benzaene compound, and porphyrin compound.

One example of the colored layer made from the composition of the present invention is a colored layer which functions as a negative C-plate. The negative C-plate has an in-plane retardation Re of approximately 0 nm, and a thickness-wise retardation Rth of 0 to 350 nm or around. Thus-characterized colored layer is preferably formed using the discotic compound represented by formula (10) below, in view of expressing desired optical characteristics only with a small amount. As described in the above, the discotic compound represented by formula (10) below is preferably used in combination with a polymer having, in the mesogen group MG thereof, the partial structure represented by formula (1a) in the above.

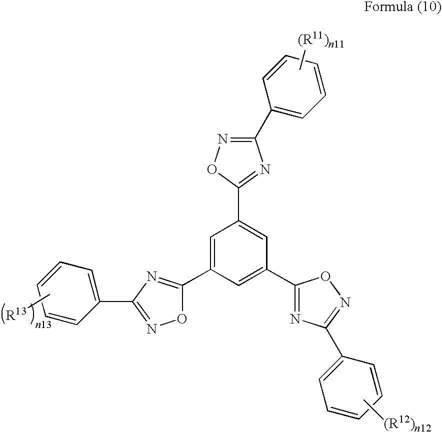

In formula (10), each of R¹¹, R¹² and R¹³ independently represents a substituent, each of n11, n12 and n13 independently represents an integer from 1 to 4, and n11 (R¹¹)s, n12 (R¹²)s and n13 (R¹³)s may be same with or different from each other.

Examples of the substituent represented by R¹¹, R¹² or R¹³ include the examples of L¹¹. Examples of the substituent include the group represented by the following formula.

*-R^{a}-R^{b}-R^{c}

In the formula, * indicates a site for linking to a phenyl.

R^{a} represents —O—, —O—CO—, —CO—O—, —O—CO—O—, —S—, —NH—, —SO₂—, —CH₂—, —CH═CH— or —C≡C—; preferably, R^{a} represents —O—, —O—CO—, —CO—O—, —O—CO—O—, —CH₂—, —CH═CH— or —C≡C—; more preferably, R^{a} represents —O—, —O—CO—, —CO—O—, —O—CO—O— or —CH₂—.

R^{b} represents a divalent linking group selected from the group consisting of —O—, —S—, —C(═O)—, —SO₂—, —NH—, —CH₂—, —CH═CH—, —C≡C— and any combinations thereof. Any hydrogen atom in —NH—, —CH₂— or —CH═CH— may be replace with another substituent. Examples of another substituent include halogen atoms, cyano, nitro, C₁₋₆ alkyls, C₁₋₆ halogenated alkyls, C₁₋₆ alkoxys, C₂₋₆ acyls, C₁₋₆ alkylthios, C₂₋₆ acyloxys, C₂₋₆ alkoxycarbonyls, carbamoyl, carbamoyls having C₂₋₆ alkyl(s), and C₂₋₆ acylaminos. Especially, halogen atoms and C₁₋₆ alkyls are preferable.

Preferably, R^{b} represents a group selected from the group consisting of —O—, —C(═O)—, —CH₂—, —CH═CH—, —C≡C— and any combinations thereof. Preferably, R^{b} has carbon atoms of from 1 to 20, and more preferably of from 2 to 14. Also preferably, R^{b} has from one to sixteen of —CH₂—, and more preferably from two to twelve —CH₂—.

R^{c} represents a polymerizable group or hydrogen atom. Using a compound wherein R^{c} is a polymerizable group, retardation may be hardly changed depending on heat, which is preferable. The polymerization is preferably carried out according to addition polymerization (whose meaning includes ring-opening polymerization) or condensation polymerization. Or in other words, the polymerizable group is preferably any group capable of carrying out addition polymerization or condensation polymerization. Examples of the polymerizable group include those shown below.

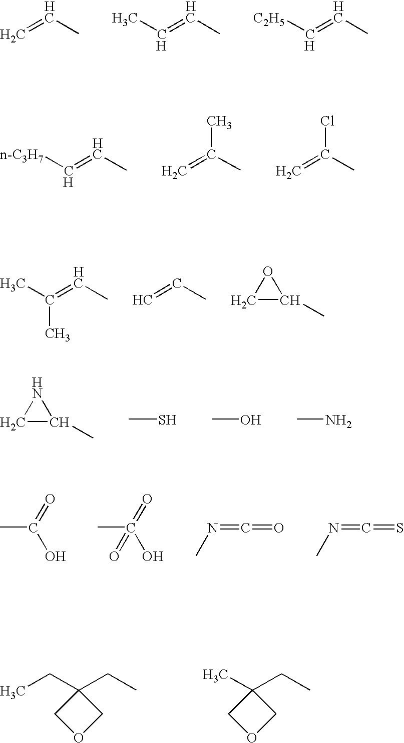

The polymerizable group is preferably any function group capable of carrying out addition polymerization. Preferable examples of such a polymerizable group include polymerizable ethylene-base unsaturated group and ring-opening polymerizable group.

Examples of polymerizable ethylene-base unsaturated group include formulae (M-1) to (M-6) shown below.

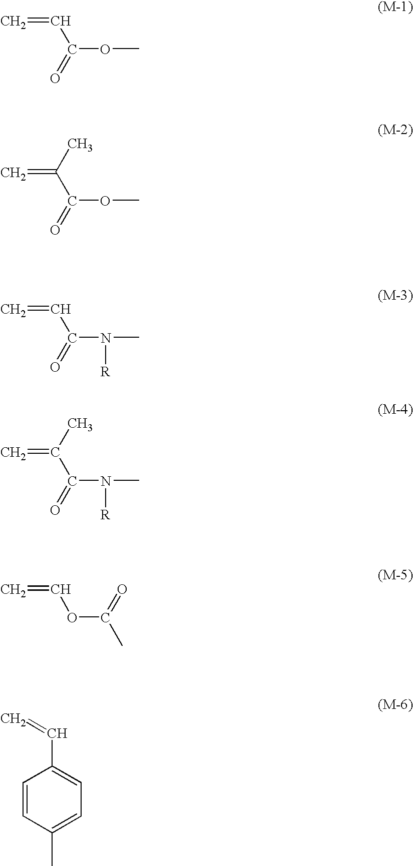

In formulae (M-3) and (M-4), R is a hydrogen atom or alkyl. R preferably represents a hydrogen atom or methyl. Among formulae (M-1) to (M-6), (M-1) or (M-2) is preferable; and (M-1) is more preferable.

Preferable examples of ring-opening polymerizable group include cyclic ether group; epoxy and oxetanyl are more preferable; and epoxy is especially preferable.

Examples of the compound represented by formula (10) include, but are not limited to, those shown below.

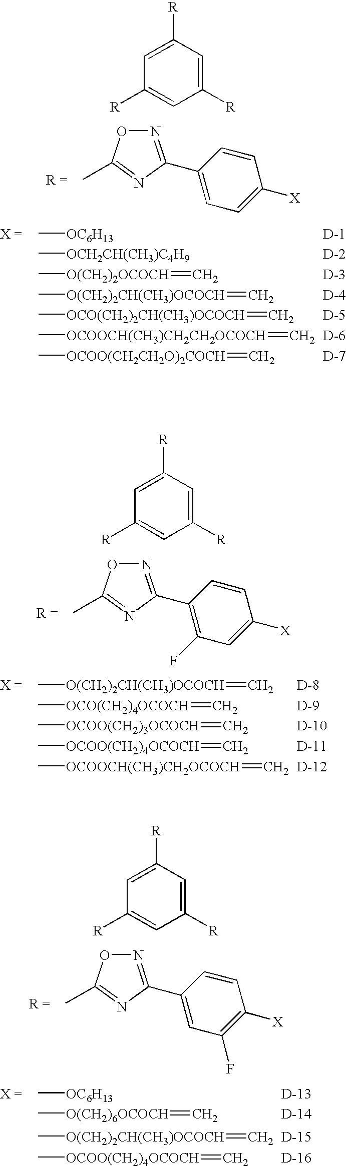

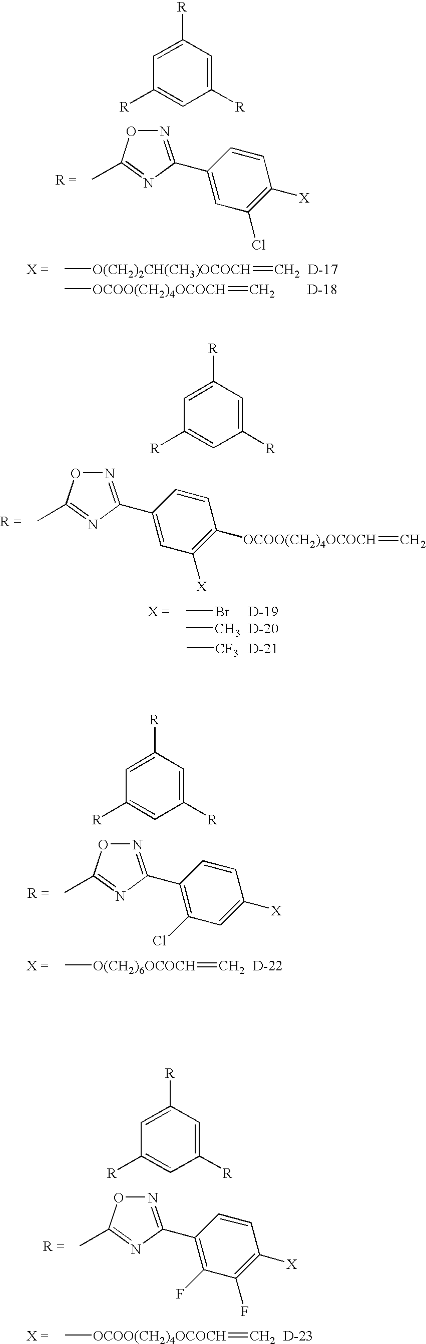

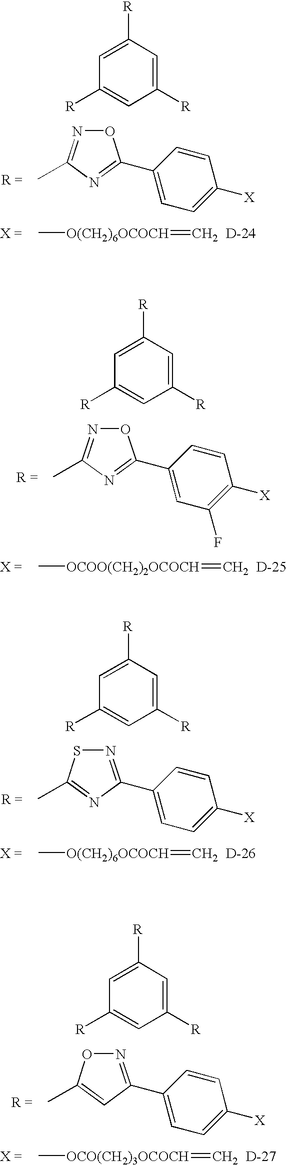

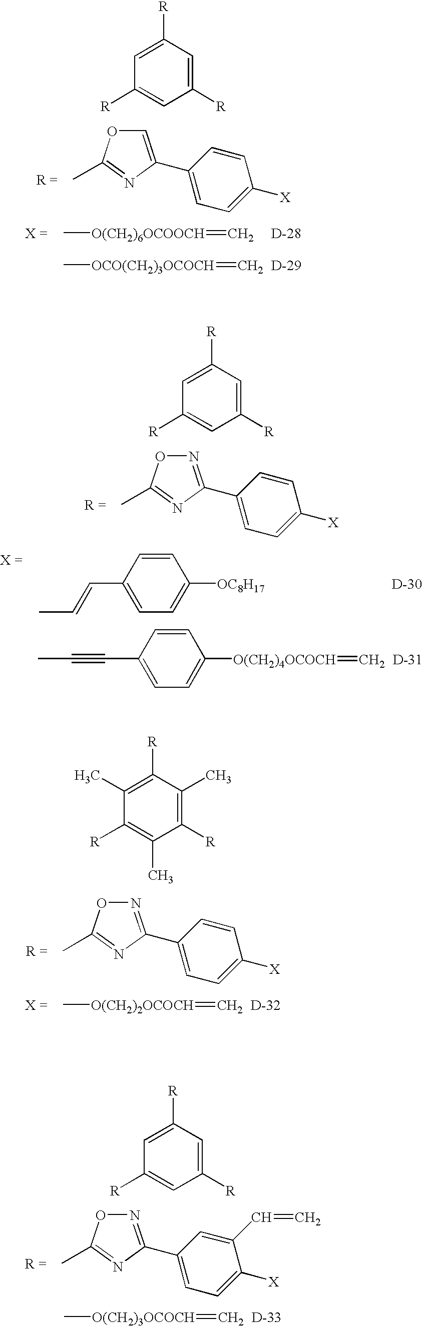

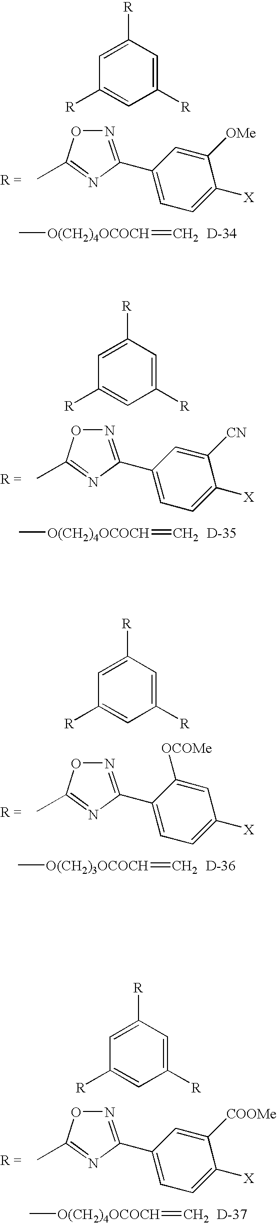

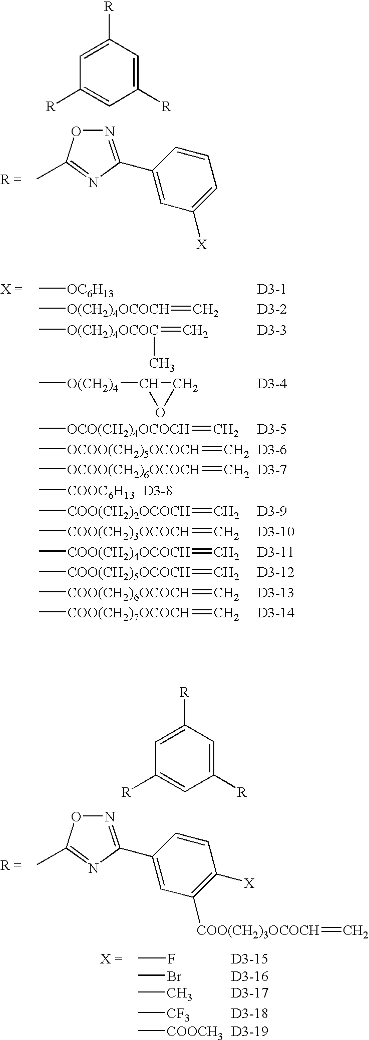

### 1.-3 Pigment

The composition of the present invention contains at least one species of pigment which may be an organic pigment or may be an inorganic pigment. For the purpose of preparing a composition used for manufacturing the color filter, organic pigments for forming color filter may be adoptable. Examples of the organic pigments for forming color filter includes those described in paragraphs [0071] to [0073] of Japanese Laid-Open Patent Publication No. 2004-339368.

### 1.-4 Preparation of Composition

The composition of the present invention may be prepared by dispersing and/or dissolving the polymer, the discotic compound and the pigment into an organic solvent, and may be obtained in a form of liquid composition. This is, for example, a liquid composition having the discotic compound and the polymer dissolved in the organic solvent having the pigment dispersed therein. By coating thus-configured composition onto a surface, and by drying the coated film to remove the solvent, the discotic compound molecules are allowed to have a predetermined state of alignment. By fixing the state of alignment typically by making use of a polymerization reaction or the like, the colored layer which shows retardation may be formed. In the composition (solid content exclusive of the solvent), the content of polymer is preferably 5 to 20% by mass or around, the content of discotic compound is preferably 5 to 20% by mass or around, and the content of pigment is preferably 5 to 30% by mass or around, but are not limited to these ranges.

In order to prepare the pigment-dispersed composition, a sand mill or the like may preferably be used for dispersing the pigment into the organic solvent.

The organic solvent adoptable to the preparation of the composition is not specifically limited, and may be selectable from a variety of organic solvents. More specifically, those listed below, and having a small content of water may preferably be used. The examples include cyclohexane, butyl acetate, ethyl acetate, 2-butanone (MEK), methyl isobutyl ketone (MIBK), toluene, xylene, methoxybutyl acetate (MBA), diethylene glycol dimethyl ether (DMDG), propylene glycol monomethyl ether acetate (PGMEA), ethyl ethoxypropionate, diethylene glycol methylethyl ether, and diethylene glycol monobutyl ether acetate. In particular, for an embodiment where the colored layer is formed by an ink-jet system, those having a boiling point of 180° C. to 260° C., in particular 210° C. to 260° C., a vapor pressure under normal temperature of 0.5 mmHg or below, in particular 0.1 mmHg or below, may preferably be used as a major solvent, in view of improving jetting performance from a head. The surface tension of the major solvent is preferably 29 dyn/cm or larger, and such solvent preferably accounts for 85% by mass or more of the total mass of the organic solvent.

### 1.-5 Other Additives

The composition of the present invention may contain additive(s) necessary for fixing the alignment of the discotic compound molecules by a polymerization reaction, after being once aligned. More specifically, an additive necessary for aligning the discotic compound, or an additive necessary for fixing the alignment by a polymerization reaction may optionally be added. Also an additive necessary for dispersing the pigment may optionally be added. These additives will be explained below.

Additives Contributive to Alignment of Discotic Compound

The discotic compound molecules are aligned to have a desired state of alignment, depending on a required level of retardation. For example, for optical compensation of VA-mode LCD, there has been proposed a system based on combination of a retardation layer (negative C-plate) which has the optical axis normal to the in-plane direction and shows negative birefringence, and a retardation layer (positive A-plate) which has the optical axis in parallel with the in-plane direction and shows positive birefringence. In an exemplary embodiment where a color filter, having a colored layer which functions as the negative C-plate, is manufactured using the composition of the present invention, the discotic compound molecules are preferably brought into homeotropic alignment. An additive for enhancing alignment of the discotic compound molecules contributes to alignment of molecules of the liquid crystalline compound, by virtue of its excluded volume effect and electrostatic effect exerted to the air interface or to the interface with the alignment film. The compounds described in Japanese Laid-Open Patent Publication Nos. 2002-20363 and 2002-129162 may be adoptable. The contents described in paragraphs [0072] to [0075] of Japanese Laid-Open Patent Publication No. 2004-53981; paragraphs [0071] to [0078] of Japanese Laid-Open Patent Publication No. 2004-4688; and paragraphs [0052] to [0054], [0065] to [0066], and [0092] to [0094] of Japanese Laid-Open Patent Publication No. 2004-139015 may optionally be adoptable to the present invention.

The content of the additive for enhancing the alignment in the composition is preferably 0.01 to 10% by mass or around with respect to the discotic compound, more preferably 0.05 to 5% by mass or around, and still more preferably 0.05 to 4% by mass or around.

Additives Contributive to Proceeding of Polymerization Reaction

The discotic compound molecules, after being aligned in the composition, are preferably fixed in the alignment in view of expressing retardation. A polymerization reaction may be adoptable to the fixation of the state of alignment. Among known polymerization reactions based on photo-polymerization system assisted by irradiation of light and thermal polymerization assisted by heat, the former is preferably used in view of fixing the initial alignment. For example, baking is generally adopted to manufacturing of the color filter, during which also the heat-assisted polymerization reaction is supposed to proceed. Additives contributive to proceeding of the polymerization reaction may be exemplified as follows.

### Photo-Polymerization Initiator:

Examples of photo-polymerization initiators include alpha-carbonyl compounds (described in U.S. Pat. Nos. 2,367,661 and 2,367,670), acyloin ether (described in U.S. Pat. No. 2,448,828), alpha-hydrocarbon-substituted aromatic acyloin compounds (described in U.S. Pat. No. 2,722,512), polynuclearquinone compounds (described in U.S. Pat. Nos. 3,046,127 and 2,951,758), combinations of triarylimidazole dimers and p-aminophenyl ketones (described in U.S. Pat. No. 3,549,367), acridine and phenadine compounds (described in JPA No. sho 60-105667 and U.S. Pat. No. 4,239,850), and oxadiazole compounds (described in U.S. Pat. No. 4,212,970).

A photo-polymerization initiator which exhibits activity at the wavelength of a light source to be adopted is added. The amount of use of the photo-polymerization initiator is preferably 0.01 to 50% by mass of the solid content of the composition, and more preferably 0.5 to 40% by mass.

Among others, 1-hydroxycyclohexyl phenylketone, and 2-methyl-1-[4-(methylthio)phenyl]-2-morpholinopropane-1-one are preferably adoptable to the present invention, by virtue of their abilities of initiating and promoting the polymerization reaction upon being irradiated by an active energy beam, only with a small amount. These compounds may be used independently, or in combination. These compounds may commercially be available, typically under the trade names of Irgacure 184, 369, 819, 907 from CIBA Specialty Chemicals, Inc.

### Chain Transfer Agent:

The composition of the present invention may be added with a chain transfer agent. The content of the chain transfer agent in the composition is preferably 0.01 to 10% by mass or around of the discotic compound, more preferably 0.05 to 5% by mass or around, and still more preferably 0.05 to 4% by mass or around. The chain-transfer agent may be selected from any known chain-transfer agents; and preferable examples of the chain-transfer agent include compounds having mercapto(s) (thiol compounds such as dodecyl mercaptan, octyl mercaptan, trimethylolpropane tris(3-mercapto propionate) and pentaerythritol tetrakis(3-mercapto propionate), and disulfide compounds such as diphenyl disulfide.

The chain transfer agent necessarily has compatibility with the discotic compound. If the discotic compound is a liquid crystalline compound, the agent is more preferably a thiol compound which exhibits liquid crystallinity, from the viewpoint of compatibility. The thiol compound which exhibits liquid crystallinity may be exemplified typically by those described in U.S. Pat. No. 6,096,241.

### Polymerizable Monomer:

The polymerizable monomer may be exemplified by radical-polymerizable or cation-polymerizable compound, preferably by multi-functional, radical-polymerizable monomer, and preferably by those co-polymerizable with the above-described discotic compound having a polymerizable group. For example, those described in paragraphs [0018] to [0020] of Japanese Laid-Open Patent Publication No. 2002-296423 may be exemplified. The amount of addition of the compound generally falls in the range from 1 to 50% by mass or around of the discotic compound, and more preferably in the range from 1 to 30% by mass or around.

Additives Contributive to Dispersion Stability of Pigment

The composition of the present invention may be added with an additive contributive to dispersion stability of the pigment. Examples of the additive include a variety of surfactants. It is also allowable to use two or more species of surfactants in combination, so as to further improve the dispersion stability. The surfactant may be exemplified by those of cationic, anionic, nonionic, amphoteric, silicone-base, and fluorine-containing ones. Examples of the surfactant include polyoxyethylene alkyl ethers such as polyoxyethylene lauryl ether, polyoxyethylene stearyl ether, and polyoxyethylene oleyl ether; polyoxyethylene alkyl phenylethers such as polyoxyethylene n-octyl phenylether, and polyoxyethylene n-nonyl phenylether; polyethylene glycol diesters such as polyethylene glycol dilaurate, and polyethylene glycol distearate; sorbitan fatty acid esters; fatty acid-modified polyesters; tertiary amine modified polyurethanes; and polyethylene imine.

Known trade names of the surfactants include KP (from Shin-Etsu Chemical Co., Ltd.), Polyflow (from Kyoeisha Chemical Co., Ltd.), F-Top (from Tochem Products Co.), Megafac (from Dainippon Ink & Chemicals, Inc.), Fluorad (Sumitomo 3M, Ltd.), Asahi Guard and Surflon (both from Asahi Glass Co., Ltd.) and so forth.

Alternatively, any other pigment dispersion aid may be added, within qualitative and quantitative ranges under which the objects and effects of the present invention will not be impaired.

Examples of the dispersant, which can be used in the invention, include amide compounds such as nonanoamide, decanamide, dodecanamide, N-dodecyl hexadecaneamide, N-octadecyl propioamide, N,N-dimethyl dodecanamid and N,N-dihexyl acetoamide; amine compounds such as diethylamine, diheptylamine, dibutylhexadecylamine, N,N,N′,N′-tetramethyl methanamine, triethylamine, tributylamine and trioctylamine; and amine compounds having hydroxy such as monoethanol amine, diethanol amine, triethanol amine, N,N,N′,N′-(tetrahydroxyethyl)-1,2-diamino ethane, N,N,N′-tri (hydroxyethyl)-1,2-diamnoethane, N,N,N′,N′-tetra (hydroxyethyl polyoxyethylene)-1,2-diamino ethane, 1,4-bis(2-hydroxyethyl)piperazine and 1-(2-hydroxy ethyl)piperazine. Other examples include nipecotamide (3-Piperidinecarboxamide), isonipecotamide and nicotinic acid amide.

Homopolymers and co-polymers of unsaturated calboxylates such as polyacrylates; (partially) amine salts, partially ammonium salts or (partially) alkylamine salts of homopolymers and co-polymers of unsaturated calboxylates such as polyacrylates; homopolymers and co-polymers of unsaturated calboxylates having hydroxy(s) such as polyacrylates having hydroxy(s), and denatured substances thereof; polyurethanes; unsaturated polyamides; polysiloxanes; phosphates of long-chain polyaminoamides; and amides and the salts thereof of products of reaction of poly(low-alkylene imine) and polyester having free carboxyl; may be used in the invention.

Examples of the commercially available dispersant include Shigenox-105 (trade name which is available from Hakkol Chemical Cooperation); Disperbyk-101, Disperbyk-130, Disperbyk-140, Disperbyk-160, Disperbyk-161, Disperbyk-162, Disperbyk-163, Disperbyk-164, Disperbyk-165, Disperbyk-166, Disperbyk-170, Disperbyk-171, Disperbyk-182 and Disperbyk-2001 (which are available from BYK Additives & Instruments); EFKA-47, EFKA-47EA, EFKA-48, EFKA-49, EFKA-100, EFKA-400 and EFKA-450 (which are available from EFKA CHEMICALS); Solsperse 12000, Solsperse 13240, Solsperse 13940, Solsperse 17000, Solsperse 20000, Solsperse 24000GR, 24000SC, Solsperse 27000, Solsperse 28000 and Solsperse 33500 (which are available from Zeneca); and PB711, PB821 and PB822 (which are available from AJINOMOTO).

Other Additives

The composition of the present invention may be added with a surfactant, polymer and so forth, aiming at improving uniformity of the coated film, strength of the film, alignability of the discotic compound and so forth. These materials preferably have compatibility with the discotic compound to be combined therewith, and are not inhibitive to the alignment, and are also not harmful to dispersibility of the pigment.

The surfactant may be exemplified by publicly-known compounds, and particularly by fluorine-containing compounds. More specifically, the compounds described in paragraphs [0028] to [0056] of Japanese Laid-Open Patent Publication No. 2001-330725 may be exemplified.

The polymer (this means a polymer other than the polymer which has the repeating unit represented by formula (1)), used in combination with the discotic compound, is preferably capable of increasing viscosity of the coating liquid. The polymer may be exemplified by cellulose ester. Preferable examples of the cellulose ester may be exemplified by those described in paragraph [0178] of Japanese Laid-Open Patent Publication No. 2000-155216. The amount of addition of the polymer preferably falls in the range from 0.1 to 10% by mass or around of the discotic compound, and more preferably in the range from 0.1 to 8% by mass or around, so as not to inhibit alignment of the discotic compound.

The composition of the present invention may be added further with UV blocker, UV absorber, surface conditioner (leveling agent) or other components, depending on needs.

### 2. Color Filter

The present invention relates also to a color filter having at least a single color of colored layer, which is composed of the composition of the present invention. The color filter is generally configured to have, on a substrate, a light-shielding black matrix, and a red (R) layer, a green (G) layer and a blue (B) layer in fine regions partitioned by the black matrix. It may be good enough for the color filter of the present invention that only a single colored layer among the R, G and B layers is composed of the composition of the present invention. Of course, all of the R, G and B layers may be composed of the composition of the present invention. Since the composition of the present invention is added with a predetermined polymer, desirable dispersibility of the pigment and desirable alignability of the discotic compound molecules are ensured. By making use of alignment of the discotic compound molecules, the colored layer successfully achieves desired optical characteristics and high contrast. By using the composition of the present invention, the colored layer having a contrast of 1000 or larger may be formed.

One embodiment of a process of preparing a color filter of the present invention includes a process of allying the composition of the present invention to a surface to thereby form a coated layer; a process of drying the coated layer to thereby align the discotic compound molecules; and a process of allowing a polymerization reaction to proceed to thereby fix the state of alignment. The process of preparing of this embodiment, making use of an ink jet system, will be explained below.

First, the composition of the present invention is prepared in a form of pigment-dispersed composition.

Next, the color filter substrate is prepared. The color filter substrate is preferably a transparent substrate. Any of those having conventionally been used as the color filter substrate, examples of which include non-flexible transparent rigid materials such as quartz glass, Pyrex (registered trademark) glass, and synthetic quartz; and transparent flexible materials such as transparent polymer film, and optical resin plate, may be adoptable. Among these, 7059 glass from Corning Inc. has a particularly small coefficient of thermal expansion and is therefore excellent in dimensional stability and handlability in the process of high-temperature heating, and is suitable for the color filter for active-matrix color liquid crystal display device, since the glass is a non-alkali glass having no alkali component contained therein. Although transparent substrates are generally adopted, also reflective or white-colored substrates may alternatively be adoptable. Still alternatively, the substrate may be given with surface modification aiming at preventing alkali leakage and imparting gas barrier performance, depending on needs.

Next, a black matrix layer is formed on one surface of the substrate, specifically in the region where the boundaries of every adjacent pixels are formed. The black matrix layer may be formed by forming a film of metal, such as chromium, of 1000 to 2000 Å thick typically by sputtering or vacuum evaporation, and then by patterning the film. A general lithographic technique may be adoptable to the patterning.

The black matrix layer may contain light-shielding particles such as those made of carbon, metal oxide, inorganic pigment, organic pigment and so forth, dispersed in the resin binder. Examples of the resin binder adoptable herein include polyimide resin, acryl resin, epoxy resin, polyacrylamide, polyvinyl alcohol, gelatin, casein, cellulose, all of which being used independently or in combination of two or more species, further include photo-curable resin, and still further include resin composition in a form of MN emulsion, such as emulsified reactive silicone. The thickness of the resin-made black matrix layer may be adjustable within the range from 0.5 to 10 μm. This sort of resin-made black matrix layer may be patterned by any of publicly known methods such as photolithography, printing and so forth.

An alignment film may occasionally be necessary to align the discotic compound molecules. The alignment film may be formed on the substrate after the black matrix was formed, or may be formed on the substrate before the black matrix is formed. Materials for composing the alignment film is not specifically limited, wherein polyimide may preferably be used from the viewpoint of its excellent heat resistance in the process of forming of the color filter. Depending on the mode of alignment of the discotic compound molecules, the alignment film may be subjected to alignment treatment such as rubbing or irradiation of light. The alignment film, for which the patterning is not specifically required, may be formed by general coating method such as spin coating, dip coating, curtain coating, extrusion coating, rod coating, roll coating and so forth.

The colored layer is formed by jetting the pigment-dispersed composition onto the surface of the substrate by the ink-jet system. For precise jetting, the methods described in Japanese Laid-Open Patent Publication Nos. 2001-350012, 2005-266629 and 2006-64858 may be adoptable.

Next, the pigment-dispersed compositions of the individual colors, each of which being added with any one of R, G and B pigments, are obtained (composition of at least one color is the composition of the present invention). The pigment dispersions, or inks, are then jetted by an ink-jet system against the surface of the substrate, specifically in the pixel forming regions of correspondent colors partitioned by the patterned black matrix layer, to thereby form the R, G and B colored layers. For example, R, G and B colored layers are formed while being arranged according to a mosaic pattern, stripe pattern, triangle pattern, quad-pixel pattern and so forth. In this process, the ink composed of the pigment-dispersed composition of the present invention is less likely to cause increase in the viscosity at the tip of the head, and may thereby keep a desirable jetting performance. As a consequence, the ink of the correspondent color may accurately and uniformly be adhered in the predetermined pixel-forming region, and thereby the pixel portion may be formed according to a correct pattern without causing non-uniformity in color and omission of dots. Since the inks for forming the pixel portions of the individual colors may alternatively be jetted against the substrate at one time using a plurality of heads, so that the working efficiency may be improved as compared with the case where the pixel portions are formed color-by-color such as by printing. In addition, since the ink using the pigment-dispersed composition of the present invention has an excellent stability as described in the above, so that the residual ink remaining after a single run over a short duration of time is not degraded in the stability. Accordingly, the residual ink may economically be recycled by recovery, or by supplementation with a fresh ink.

Next, the ink layers of the individual colors, that are R layer, G layer and B layer, are respectively dried, followed by pre-baking if necessary, and then heated to allow the liquid crystalline compound to align. After the alignment, light is irradiated to fix the alignment. Succeeding heating of the ink layers allows the residual polymerizable group to react, to cure the ink layers. The thickness of the pixel portion is generally adjusted to 0.1 to 2.0 μm or around, taking optical characteristics into consideration.

The alignment of the liquid crystal compound necessarily takes place at a temperature at which the liquid crystal phase appears. The alignment is generally believed to more readily proceed at higher temperatures, meanwhile in the present invention, preferably making use of the liquid crystalline compound which contains the polymerizable group in order to fix the state of alignment, too high temperature undesirably allows thermal polymerization reaction to proceed, and thereby the fixation in a uniform state of alignment results in failure. In the state having the solvent vaporized off from the pigment-dispersed composition, the colored layers preferably show a liquid crystal phase at a temperature of 180° C. or below, and more preferably 160° C. or below. For the purpose of obtaining a uniform state of alignment, it is preferable to control the temperature of the ink layers so as to keep them at a constant temperature, so as to cool them down from a certain temperature, or so as to heat them up from a certain temperature, selectively depending on the pigment-dispersed composition adopted thereto.

The irradiation of light for fixing the alignment by way of polymerization of the liquid crystal compound is preferably conducted by using ultraviolet radiation. The energy of irradiation is preferably 20 mJ/cm² to 50 J/cm², and more preferably 100 mJ/cm² to 10 J/cm². A sensitizer may optionally be used for the purpose of promoting the photo-polymerization reaction. Since the irradiation of light is aimed at fixing the state of alignment, so that the irradiation of light is conducted at a temperature at which the state of alignment may be maintained.

Next, a protective film is formed on the transparent substrate on the side thereof having the pixel portion, having R pixels, G pixels and B pixels, formed thereon. The thickness of the protective film may be set, taking the transmissivity of light of the materials adopted herein, and surface conditions of the color filters into consideration, typically in the range from 0.1 to 2.0 μm. The protective film may be formed typically by preparing a coating solution for forming the protective film, using a material which has a transmissivity of light and so forth required for the transparent protective film, selected from publicly-known transparent photo-curable resin, two-part-curable transparent resin and so forth, and by coating the coating liquid using a spin coater at a rotation speed of 500 to 1500 rpm.

A transparent electrode on the protective film may be formed using indium tin oxide (ITO), zinc oxide (ZnO), tin oxide (SnO), or composites of these oxides, by a general method such as sputtering, vacuum evaporation, CVD or the like, optionally followed by patterning based on etching using a photoresist, or based of use of a jig. The thickness of the transparent electrode may be adjusted to 20 to 500 nm or around, and preferably to 100 to 300 nm or around.

For an exemplary case where columnar spacers are formed on the transparent electrode, the spacers may be formed similarly by the above-described method of dispersing pigment.

In this way, the color filter may be manufactured by the ink-jet system using the pigment-dispersed composition of the present invention.

The color filter manufactured using the constituents of the present invention exhibits retardation, wherein the optimum retardation may vary depending on the drive system of LCD and other retardation plates used in combination therewith. The optimum retardation may vary depending also on wavelengths of R, G and B. According to the color filter of the present invention, the retardation to be exhibited may arbitrarily be controlled, by altering species of the liquid crystalline compound, the amount of addition and compositional ratios, depending on situation of use.

### EXAMPLES

The present invention will be explained to further detail, referring to Examples. Note that the materials, reagents, amounts and ratios of substances, operations and so forth explained in Examples below may appropriately be modified without departing from the spirit of the present invention. The scope of the present invention is, therefore, not limited to the specific examples described below.

### Example 1

### Synthesis of Polymer

### 1. Synthesis of Polymer 1

Polymer 1 illustrated in the next was synthesized according to a synthetic route illustrated below.

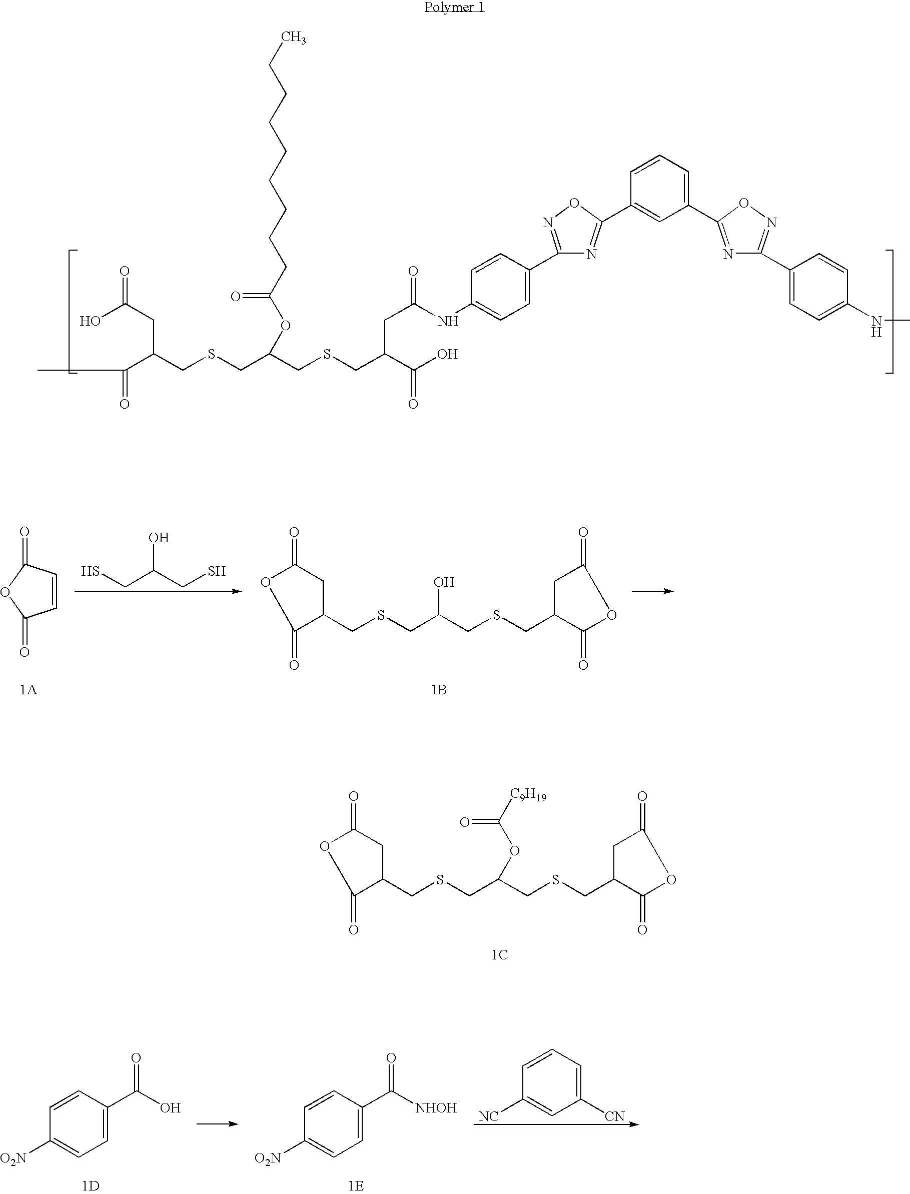

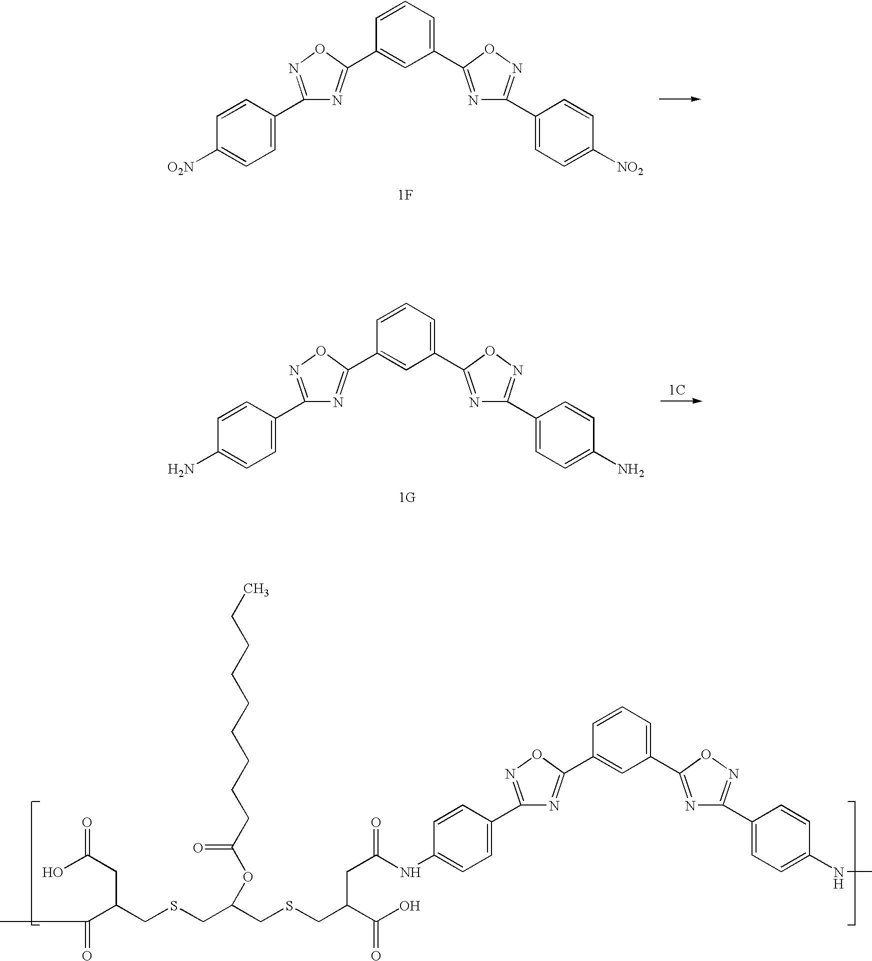

Compound 1C was obtained from compound 1A as a starting material, making use of publicly-known reactions according to the synthetic route illustrated in the above.

Also compound 1G was obtained from compound 1D as a starting material, making use of publicly-known reactions according to the synthetic route illustrated in the above.

In a 100-mL, four-necked flask provided with a stirrer, a nitrogen inlet, a thermometer and an inlet for feeding source materials, 15.8 g (40 mmol) of compound 1G was placed, and dissolved in 52 g of N-methyl-2-pyrrolidone (NMP). Ten grams (20 mmol) of compound 1C was then added, and the mixture was stirred for 6 hours. The weight-average molecular weight of the polymer in this solution, measured by gel permeation chromatography (column: Shodex GF-7 MHQ, solvent: DMF, flow rate: 0.5 ml/min, measuring temperature: 50° C.) using a polystyrene standard, was found to be 57,000.

### 2. Synthesis of Polymer 2

Polymer 2 illustrated below was synthesized according to a method similar to that for polymer 1.

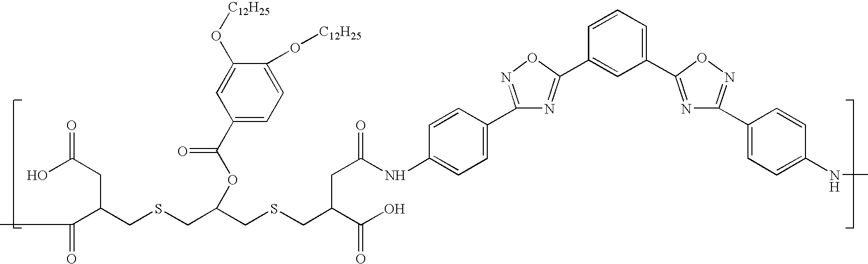

The weight-average molecular weight of the polymer was found to be 46,000.

### Example 2

### Preparation of Green Colored Layer

### 1. Preparation of Composition 1 for Forming Green Colored Layer

Composition 1 for forming a green colored layer was prepared according to the formulation below.

| | | |
|---|---|---|
| Liquid crystal compound: liquid crystal compound A having a structure illustrated | 20 | parts by mass |
| below | | |
| Polymer: polymer 1 synthesized in Example 1 | 30 | parts by mass |
| First polymerization initiator: Irg907 (from CIBA Specialty Chemicals, Inc.) and | 10 | parts by mass |
| second polymerization initiator: Irg306 (from CIBA Specialty Chemicals, Inc.) | | |
| Sensitizer: Hicure ABP (from Kawaguchi Chemical Co., Ltd.) | 0.6 | parts by mass |
| Pigment: dispersion liquid of PG36/PG7/PY138 (solvent: propylene glycol | 200 | parts by mass |
| monomethyl ether acetate, solid content 30%) | | |
| Solvent: propylene glycol monomethyl ether acetate | 350 | parts by mass |

Liquid crystal compound A:

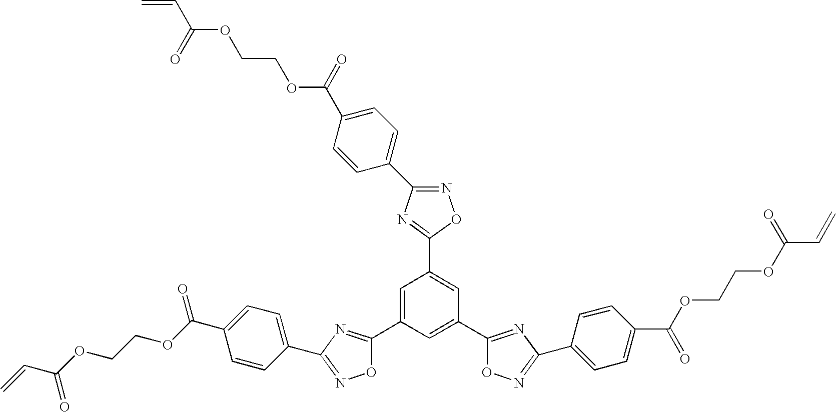

### 2. Formation of Colored Layers

On a glass substrate of 0.63 mm thick (1737 glass from Corning Inc.), used as the transparent substrate, composition 1 for forming green colored layer was coated, and heated on a hot plate to dryness. The coated film was then exposed to light, developed and baked, to thereby form the green colored layer. Measurement of retardation of a sample of the obtained colored layer, made at 545 nm, revealed that Re(545) was approximately 0 nm, and Rth(545) was 35 nm.

The contrast of the colored layer was found to be 2500.

### Example 3

### Preparation of Colored Layer

### 1. Preparation of Dispersion Liquid A

One hundred parts by mass of finely pulverized pigment Fastogen Green 2YK (from Dainippon Ink & Chemicals, Inc.) was added with 40 parts by mass of polymer 2 synthesized in Example 1, and 326 parts by mass of propylene glycol monomethyl ether acetate as a solvent, and the mixture was allowed to disperse using a paint shaker containing 0.4-mm-diameter zirconia beads under a ratio of filling of 20%, to thereby prepare 466 parts by mass of dispersion liquid A.

### 2. Preparation of Composition 2 for Forming Green Colored Layer

Composition 2 for forming a green colored layer was prepared according to the composition below.

| | |
|---|---|
| Liquid crystal compound: liquid crystal compound | 20 parts by mass |
| A illustrated in the above | |
| Polymer: polymer 2 synthesized in Example 1 | 13 parts by mass |
| First polymerization initiator: Irg907 (from | 10 parts by mass |
| CIBA Specialty Chemicals, Inc.) and second poly- | |
| merization initiator: Irg306 (from CIBA Specialty | |
| Chemicals, Inc.) | |
| Sensitizer: Hicure ABP (from Kawaguchi Chemical | 0.6 parts by mass |
| Co., Ltd.) | |
| Pigment: dispersion liquid A (solvent: propylene | 200 parts by mass |
| glycol monomethyl ether acetate, solid content 30%) | |
| prepared in the above | |
| Solvent: propylene glycol monomethyl ether acetate | 350 parts by mass |

### 3. Formation of Colored Layer

On a glass substrate of 0.63 mm thick (1737 glass from Corning Inc.), used as the transparent substrate, composition 2 for forming green colored layer was coated, and heated on a hot plate to dryness. The coated layer was then exposed to light, developed and baked, to thereby form the green colored layer. Measurement of retardation of a sample of the obtained colored layer, made at 545 nm, revealed that Re(545) was approximately 0 nm, and Rth(545) was 49 nm.

The contrast of the colored layer was found to be 3000.

### Comparative Example 1

### Manufacturing of Colored Layer

### 1. Synthesis of Dispersion Aid

According to the method described in paragraphs [0054] to [0055] of Japanese Laid-Open Patent Publication No. 10-339949, polymethacrylate containing 3-(N,N-dimethylamino)propyl acrylamide and terminal methacryloyl group was synthesized, and used as a dispersion aid.

### 2. Preparation of Dispersion Liquid B

Dispersion liquid B was prepared by a method similar to that of preparing dispersion liquid A described in Example 3, except that the polymer synthesized in the above was used, in place of polymer 2 synthesized in Example 1.

### 3. Preparation of Composition 3 for Forming Green Colored Layer

Composition 3 for forming the green colored layer was prepared by a method similar to that of preparing composition 2 described in Example 3, except that dispersion liquid B prepared in the above was used in place of dispersion liquid A, and that the polymer synthesized in the above was used in place of polymer 2 synthesized in Example 1.

### 4. Formation of Colored Layer

A coated film was formed similarly to as described in Example 3, except that composition 3 for forming the green colored layer prepared in the above was used in place of composition 2 for forming the green colored layer used in Example 3. Observation of the coated film under a polarization microscope, while heating the sample at 90° C., revealed that the schlieren persists, indicating that the liquid crystal molecules did not uniformly align in the coated film. The coated film was then exposed to light, to thereby obtain the colored layer.

The contrast of a sample of the colored layer was found to be 100 or around.

1. A composition comprising at least a polymer which comprises a repeating unit represented by formula (1), a discotic compound and a pigment: 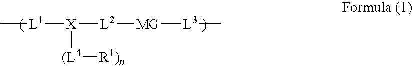
where, each of L¹, L², L³ and L⁴ independently represents a divalent linking group; X represents an (n+2)-valent linking group; R¹ represents a substituted or non-substituted, alkyl group, alkenyl group, alkynyl group, aryl group, aralkyl group, or hetero ring residue; n represents an integer from 1 to 4, and n (L⁴)s and n (R¹)s may be same with or different from each other; and MG represents a mesogen group.

2. The composition of claim 1, wherein in formula (1), R¹ comprises an alkyl chain, alkenyl chain or alkynyl chain, having 3 or more and less than 20 carbon atoms.

3. The composition of claim 1, wherein in formula (1), X represents a trivalent group represented by the formula below: 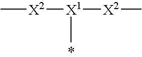
wherein, X¹ represents an alkylene group having 3 or more and less than 20 carbon atoms, X² represents an oxygen atom or sulfur atom, and * represents a binding site with L⁴.

4. The composition of claim 1, wherein in formula (1), each of L¹, L², L³ and L⁴ independently represents any one divalent linking group selected from a group consisting of a substituted or non-substituted alkylene group, a substituted or non-substituted arylene group, a substituted or non-substituted divalent hetero ring residue, —CO—, —NH—, oxygen atom, sulfur atom, and any combinations thereof.

5. The composition of claim 1, wherein in formula (1), L¹ represents —CO-L¹¹- or NH-L¹¹-; L³ represents -L³¹-NH— or L³¹-CO—; L² represents -L²¹-CONH-L²²- or L²¹-NHCO-L²²-; each of L¹¹, L³¹, L²¹ and L²² independently represents a single bond, substituted or non-substituted alkylene group, substituted or non-substituted arylene group, or substituted or non-substituted divalent hetero ring residue.

6. The composition of claim 1, wherein in formula (1), MG represents a mesogen group represented by any one of formulae below: 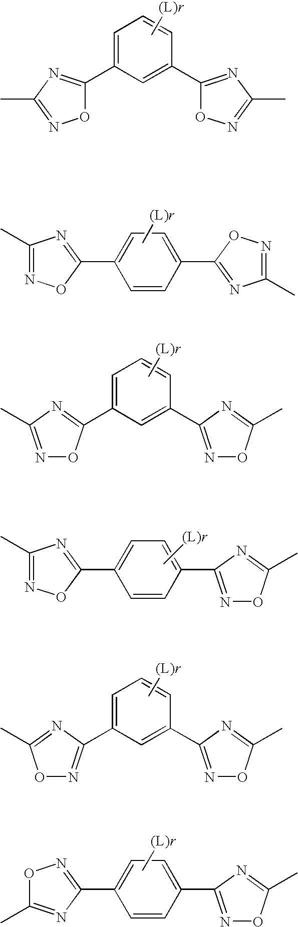
where, L represents a substituent; r represents an integer form 0 to 4; and if r=2, two (L)s may be same with or different from each.

7. The composition of claim 1, wherein the discotic compound and MG in formula (1) in the above have a same partial structure.

8. The composition of claim 1, wherein the discotic compound is a compound represented by formula (10) below, and MG in formula (1) in the above represents a group represented by formula (1a) below, or a group containing a group represented by formula (1a) below as a partial structure: 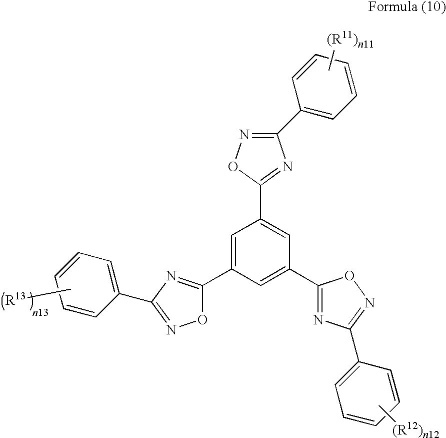
where, each of R¹¹, R¹² and R¹³ independently represents a substituent, each of n11, n12 and n13 represents an integer from 1 to 4, n11 (R₁₂)s, n12 (R¹²)s and n13 (R¹³)s may be same with or different from each other; 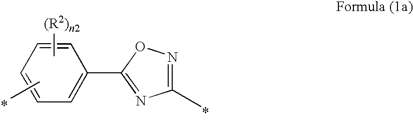
where, R² represents a substituent, n2 represents an integer from 0 to 4, and if n2≧2, (R²)s may be same with or different from each other; and * represents a binding site to L² or L³, or a binding site to other partial structure in MG.

9. The composition of claim 1, wherein said pigment is an organic pigment for color filters.

10. A color filter comprising at least one color of colored layer composed of said composition of claim 1.

11. The color filter of claim 10, wherein said colored layer shows retardation.

12. A method for preparing a color filter comprising:
applying the composition of claim 1 to a surface to thereby form a coated layer;
drying said coated layer to thereby align molecules of the discotic compound; and
allowing a polymerization reaction to proceed to thereby fix the state of alignment.
